(19) United States
(12) Patent Application Publication
(10) Pub. No.: US 2025/0357826 A1
(43) Pub. Date: Nov. 20, 2025

(54) STATOR CORE OF MOTOR HAVING COOLING STRUCTURE

(71) Applicant: HYUNDAI MOBIS CO., LTD., Seoul (KR)

(72) Inventor: Dae Wook KIM, Yongin-si (KR)

(73) Assignee: HYUNDAI MOBIS CO., LTD., Seoul (KR)

(21) Appl. No.: 19/212,134

(22) Filed: May 19, 2025

(30) Foreign Application Priority Data
May 17, 2024 (KR) 10-2024-0064359

(51) Int. Cl. H02K 9/22; H02K 1/20; H02K 3/50; H02K 9/19

(52) U.S. Cl. CPC H02K 9/223; H02K 1/20; H02K 3/50; H02K 9/19

(57) ABSTRACT

Disclosed is a cooling structure of an electric motor, and more particularly to a stator core having a cooling structure to cool a central portion of the stator core of a motor. An aspect of the disclosure is to provide a stator cooling structure of the motor to efficiently cool the central portion of the stator core of the motor.

### CROSS REFERENCE TO RELATED APPLICATION

The present application claims priority to Korean Patent Application No. 10-2024-0064359, filed May 17, 2024, the entire contents of which is incorporated herein for all purposes by this reference.

### BACKGROUND OF THE INVENTION

### Field of the Invention

The disclosure relates to a cooling structure of an electric motor, and more particularly to a stator core having a cooling structure to cool a central portion of the stator core of a motor.

### Description of the Related Art

A hybrid vehicle is driven in an electric vehicle (EV) mode, i.e., a pure electric vehicle mode using only the power of a driving motor, or in a hybrid electric vehicle (HEV) mode using both the rotational power of an engine and the driving motor as power. In this way, the driving motor used as a power source of the vehicle includes a stator core and a rotor core, in which the stator core is coupled to the inside of a motor housing, and the rotor core is disposed inside the stator core.

FIG. 1 is a schematic diagram of a cooling structure for a conventional motor 10. As shown therein, a stator core 11 includes a core body 12 made of an electrical steel plate, a coil 13 wound around a core body 12, and end coils 14 placed above and below the core body 12, and high temperature heat is generated according to current applied to the coil 13. Further, an eddy current is generated in the stator core 11 by a counter electromotive voltage caused by change in magnetic flux generated by a rotating magnet and current applied to the coil 13. Therefore, such current generates high temperature heat in the stator corer, and thus the driving motor mounted to the vehicle should be cooled to prevent damage caused by the heat and to ensure continuously stable operation.

As a method of cooling the driving motor, there are an oil-cooling method using oil and a water-cooling method using cooling water. In the oil-cooling method, a cooling pipe is installed between the stator core and the motor housing to cool the stator core. Specifically, the cooling pipe includes a pair of straight pipes and a pair of round pipes, in which the straight pipe extends parallel to a coupling portion, thereby spraying oil onto the core body to be cooled.

To cool the core, a flow path 15 through which oil flows may be formed on an outer circumferential surface of the core, and a press-fitting portion may also be provided on the outer circumferential surface of the core to be fitted to the motor housing 16.

The foregoing cooling structure has a problem in that the performance of cooling the central portion located in the inner circumferential surface of the stator core 11 is lowered because the motor is cooled by the oil flowing between the outer circumferential surface of the stator body 12 and the motor housing 16.

Therefore, it is required to develop technology for efficiently cooling the overall stator core.

### SUMMARY OF THE INVENTION

The disclosure has been conceived to solve the foregoing problems, and an aspect of the disclosure is to provide a stator cooling structure of a motor to efficiently cool a central portion of a stator core of the motor

In more detail, an aspect of the disclosure is to provide a stator cooling structure of a motor, in which a thermally conductively material is inserted in a tooth formed in a coil winding portion of a stator core, thereby cooling a central portion of the stator core.

According to an embodiment of the disclosure, a stator core of a motor having a cooling structure includes: a stator body having a hollow inner portion, and including a plurality of teeth recessed from an inner circumferential surface outwards in a radial direction and formed along a circumferential direction; a coil wound around the plurality of teeth; and a thermal conductive unit provided on the inner circumferential surface of the stator body and configured to transfer heat from the inner circumferential surface of the stator body outwards in an axial direction, the thermal conductive unit being made of a thermally conductive material to transfer heat from the inner circumferential surface of the stator body outwards in the axial direction, and including a conductive rod provided on the inner circumferential surface of the stator body and including a first end exposed to a first side of the stator body in the axial direction and a second end exposed to a second side of the stator body in the axial direction.

The conductive rod may be inserted in an empty space formed at an inner end of the tooth in a radial direction.

Further, the thermal conductive unit may include: a first conductive plate connecting with a first side of the conductive rod in the axial direction, and provided to be in contact with the first side of the stator body in the axial direction; and a second conductive plate connecting with a second side of the conductive rod in the axial direction, and provided to be in contact with the first side of the stator body in the axial direction.

Further, the first and second conductive plates may include: a first tooth corresponding groove recessed from the inner circumferential surface outwards in the radial direction to correspond to the tooth of the stator body; and a connection ring formed to seal an opening of the first tooth corresponding groove along the inner circumferential surfaces of the first and second conductive plates, and an end portion of the conductive rod may be coupled to the connection ring.

Further, the thermal conductive unit may include copper, aluminum, a copper alloy, an aluminum alloy, or thermally conductive plastic.

The conductive rod may include a plurality of conductive rods provided on only some of the plurality of teeth.

In addition, the stator core may further include an oil flow groove formed on an outer circumferential surface of the stator body along the axial direction and recessed inwards in the radial direction to flow oil for cooling therein, wherein the first and second conductive plates include oil corresponding grooves recessed from outer circumferential surfaces inwards to correspond to an end portion of the oil flow groove.

### BRIEF DESCRIPTION OF THE DRAWINGS

FIG. 1 is a schematic view showing a conventional structure of a motor.

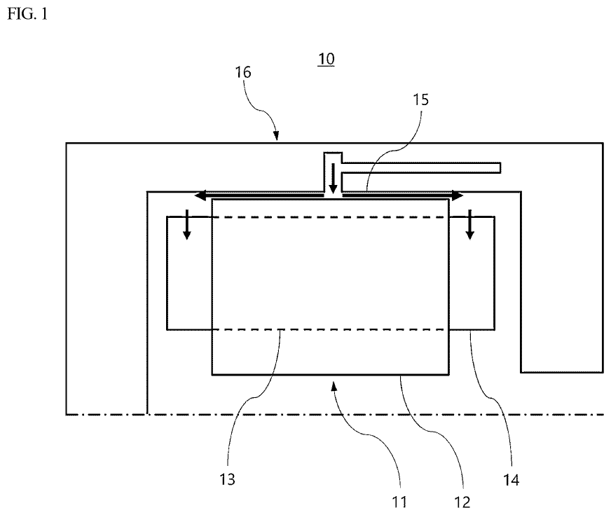

FIG. 2 is a perspective view of a stator cooling structure of a motor according to the disclosure.

FIG. 3 is a perspective view showing that a stator body and a thermal conductive unit of a stator core according to the disclosure are coupled.

FIG. 4 is a perspective view of a thermal conductive unit according to the disclosure.

FIG. 5 is a partial plan view of a stator core to which a thermal conductive unit of the disclosure is applied.

FIG. 6 is a partially cutaway perspective view showing a cooling process of a cooling structure according to the disclosure.

### DETAILED DESCRIPTION OF THE INVENTION

Below, embodiments of the disclosure will be described in detail with reference to the accompanying drawings.

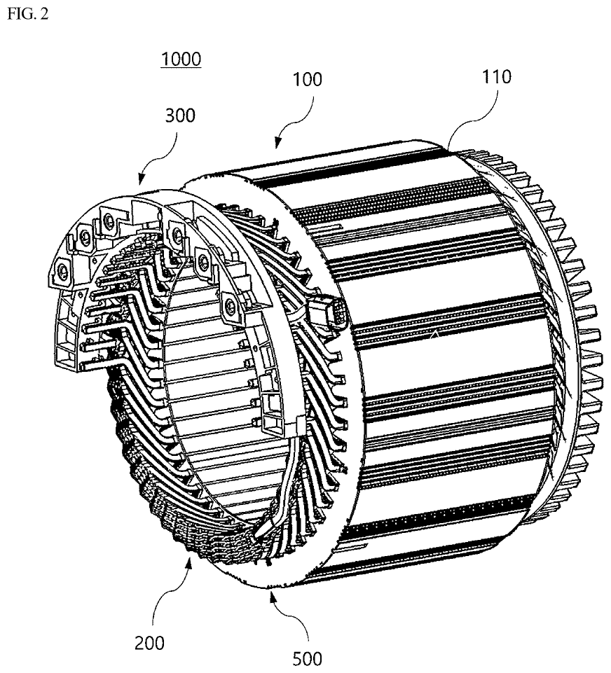

FIG. 2 is a perspective view of a stator core 1000 to which a stator cooling structure of a motor according to the disclosure is applied.

As shown therein, the stator core 1000 includes a stator body 100, a coil 200, and a terminal 300. The stator body 100 includes a plurality of concentric ring-shaped split cores stacked in an axial direction. The coil 200 is wound around the stator body 100, and a rotating magnetic field is formed by the magnetic flux generated by the coil 200. The stator body 100 may be shaped like a cylinder, the first and second ends of which communicate with each other. A rotor core may be positioned in the hollow of the stator body 100. The terminal 300 may be provided on a first or second side of the stator body 100 in an axial direction, and include a tab connected to each coil 200 and a terminal housing for holding each tab.

Therefore, when an electromagnetic field is generated around the stator core 1000 as an electric motor is powered, the stator core 1000 and the rotor interact with each other, thereby driving the rotor (not shown) to rotate relative to the stator core 1000.

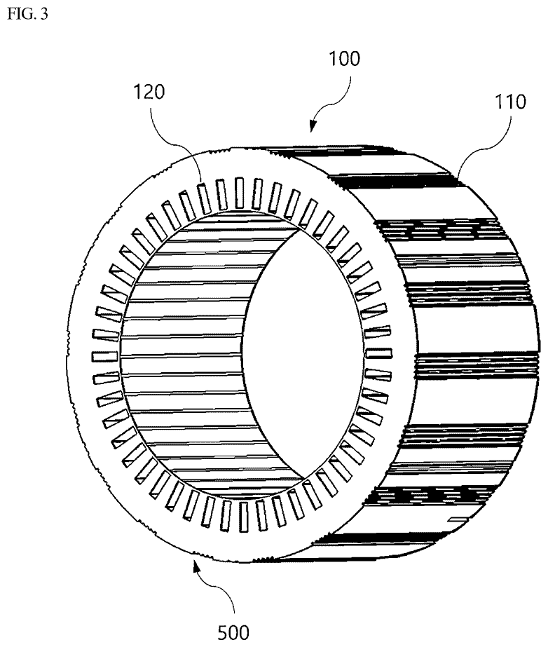

In this case, an oil flow groove 110 may be formed on the outer circumferential surface of the stator body 100 along the axial direction and recessed inwards in a radial direction. Therefore, oil supplied to the outer circumferential surface of the stator body 100 may flow along the oil flow grooves 110, thereby cooling the stator core 1000. Further, a tooth 120 (see FIG. 3) for winding the coil 200 may be formed on the inner circumferential surface of the stator body 100. The tooth 120 may be recessed from the inner circumferential surface of the stator body 100 outwards in the radial direction, and may be formed along the axial direction. In addition, a plurality of teeth 120 may be arranged at equal intervals along a circumferential direction on the inner circumferential surface of the stator body 100.

Meanwhile, the stator core 1000 may further include a thermal conductive unit 500 to dissipate heat generated in a central portion inside the inner circumferential surface of the stator body 100 outwards. The thermal conductive units 500 are provided on the teeth 120 and the first and second side outer surfaces of the stator body 100 in the axial direction to transfer the heat from the central portion to the first and second side outer surfaces of the stator body 100 in the axial direction so that the stator body 100 can be cooled by the oil supplied to the stator core 1000.

Below, the specific configuration of the thermal conductive unit 500, i.e., the key component of the motor with the foregoing stator cooling structure, will be described in detail with reference to the accompanying drawings.

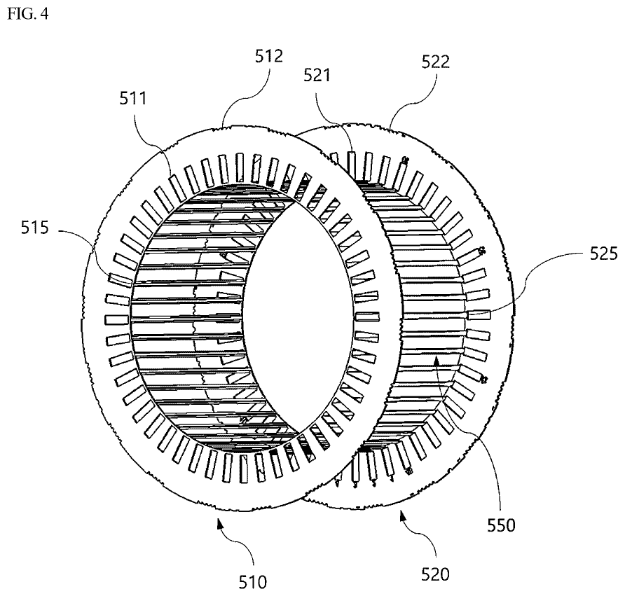

FIG. 3 is a perspective view showing that the stator body 100 and the thermal conductive unit 500 of the stator core 100 according to the disclosure are coupled, and FIG. 4 is a perspective view of the thermal conductive unit 500 according to the disclosure.

As shown therein, the thermal conductive unit 500 may include a first conductive plate 510 provided to be in contact with the first side surface of the stator body 100 in the axial direction, a second conductive plate 520 provided to be in contact with the second side surface of the stator body 100 in the axial direction, and a conductive rod 550 having a first end connected to the first conductive plate 510 and a second end connected to the second conductive plate 520. The thermal conductive unit 500 may be made of a material having high thermal conductivity, for example, copper, aluminum, or alloys thereof. More specifically, the thermal conductive unit 500 may be made of a paramagnetic material, i.e., aluminum. As another example, the thermal conductive unit 500 may be made of thermally conductive plastic.

The first conductive plate 510 is shaped corresponding to the first side of the stator body 100 in the axial direction so as to be in contact with the first side surface of the stator body 100 in the axial direction. Therefore, the first conductive plate 510 may be shaped like a ring with a hollow center. Further, the first conductive plate 510 may be formed with a first tooth corresponding groove 511 to correspond to the tooth 120 of the stator body 100. The first tooth corresponding groove 511 may be recessed from the inner circumferential surface of the first conductive plate 510 outwards in the radial direction, and a plurality of first tooth corresponding grooves 511 may be spaced apart radially from each other. Further, the first conductive plate 510 may have a first oil corresponding groove 512 formed to correspond to the oil flow groove 110 of the stator body 100. The first oil corresponding groove 512 may be recessed from the outer circumferential surface of the first conductive plate 510 inwards in the radial direction, and a plurality of first oil corresponding groove 512 may be formed along a circumferential direction to correspond to the oil flow grooves 110. In addition, the first conductive plate 510 may include a first connection ring 515 formed along the inner circumferential surface of the first conductive plate 510. The first connection ring 515 may be configured to connect the conductive rods 550, and also to seal an opening of the first tooth corresponding groove 511.

The second conductive plate 520 is shaped corresponding to the second side of the stator body 100 in the axial direction so as to be in contact with the second side surface of the stator body 100 in the axial direction. Therefore, the second conductive plate 520 may be shaped like a ring with a hollow center. Further, the second conductive plate 520 may be formed with a second tooth corresponding groove 521 to correspond to the tooth 120 of the stator body 100. The second tooth corresponding groove 521 may be recessed from the inner circumferential surface of the second conductive plate 520 outwards in the radial direction, and a plurality of second tooth corresponding grooves 521 may be spaced apart radially from each other. Further, the second conductive plate 520 may have a second oil corresponding groove 522 formed to correspond to the oil flow groove 110 of the stator body 100. The second oil corresponding groove 522 may be recessed from the outer circumferential surface of the second conductive plate 520 inwards in the radial direction, and a plurality of second oil corresponding groove 522 may be formed along a circumferential direction to correspond to the oil flow grooves 110. In addition, the second conductive plate 520 may include a second connection ring 525 formed along the inner circumferential surface of the second conductive plate 520. The second connection ring 525 may be configured to connect the conductive rods 550, and also to seal an opening of the second tooth corresponding groove 521.

The conductive rod 550 may be formed along the axial direction and fitted to the inner end of the teeth 120 of the stator body 110 in the radial direction. Further, the conductive rod 550 may include an end portion including a first end in the axial direction to couple with the first connection ring 515 of the first conductive plate 510, and a second end in the axial direction to couple with the second connection ring 525 of the second conductive plate 520. Accordingly, the conductive rod 550 may be configured to transfer heat generated in the central portion of the stator body 110 to the first and second conductive plates 510 and 520. The conductive rod 550 may be provided on all the teeth of the stator body 110 or may be provided on only some teeth.

The thermal conductive unit 500 with the foregoing configuration is configured to cool the first and second conductive plates 510 and 520 and the conductive rod 550 through heat exchange between the first and second conductive plates 510 and 520 and the oil supplied through the first and second oil corresponding grooves 522 of the first and second conductive plates 510 and 520.

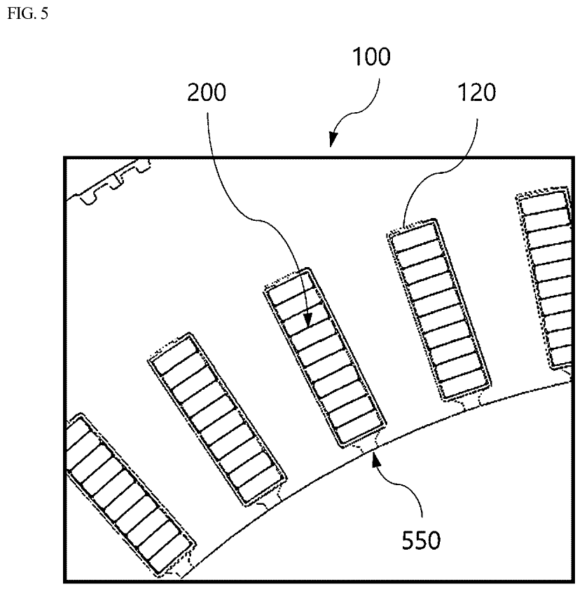

FIG. 5 is a partial plan view of the stator core 1000 to which the thermal conductive unit 500 of the disclosure is applied.

As described above, the teeth 120, around which the coil 200 is wound, is formed in the stator body 100 of the stator core 1000 along the circumferential direction. In this case, the inner end of the tooth 120 in the radial direction has an empty space into which the conductive rod 550 of the thermal conductive unit 500 is inserted. Accordingly, no design change is required and there is no increase in volume even though the conductive rod 550 is added to the general configuration of the stator core, and thus there is an advantage in that the conductive rod 550 is simply applicable to the existing stator core.

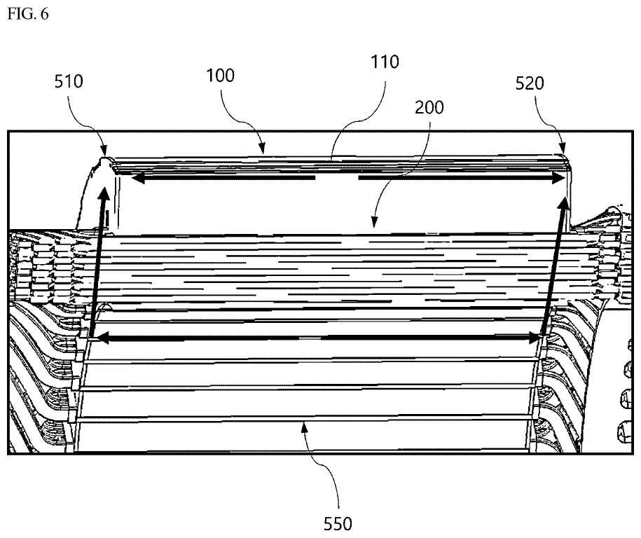

FIG. 6 is a partially cutaway perspective view showing the process of cooling the central portion of the stator core 1000 having a cooling structure according to the disclosure. As shown therein, heat generated in the central portion of the stator body 100 may be transferred to the first and second conductive plates 510 and 520 provided on the first and second side of the stator body 100 in the axial direction through the conductive rod 550. Meanwhile, the cooling oil flowing along the oil flow groove 120 formed on the outer surface of the stator body 100 may be delivered to the first and second conductive plates 510 and 520 along the first and second oil corresponding grooves 512 and 522 of the first and second conductive plates 510 and 520, and exchange heat with the first and second conductive plates 510 and 520 and the conductive rod 550, thereby cooling the central portion of the stator body 100.

With the foregoing configuration, the stator cooling structure of the motor according to the disclosure has an effect on efficiently cooling the central portion of the stator core.

Further, thermal conduction is used to quickly transfer heat from the central portion of the stator core to a space where oil flows, thereby having an effect on further improving the performance of cooling the central portion.

In addition, no design change is required and there is no increase in volume as the thermally conductive material is inserted into the empty space, i.e., the teeth of the stator core to improve the performance of cooling the central portion, thereby having an effect on being easily applicable to the existing configuration of the motor.

The technical idea should not be construed as limited to the foregoing embodiments of the disclosure. The scope of application is diverse, and various modifications may be made at a level of those skilled in the art without departing from the gist of the disclosure claimed in the appended claims. Accordingly, such improvements and modifications fall within the scope of the disclosure as long as they are obvious to those skilled in the art.

### DESCRIPTION OF REFERENCE NUMERALS

1000: stator core
100: stator body
110: oil flow groove
120: tooth
200: coil
300: terminal
500: thermal conductive unit
510: first conductive plate
511: first tooth corresponding groove
512: first oil corresponding groove
515: first connection ring
520: second conductive plate
521: second tooth corresponding groove
522: second oil corresponding groove
525: second connection ring
550: conductive rod

What is claimed is:

1. A stator core of a motor having a cooling structure, comprising:
a stator body having a hollow inner portion, and comprising a plurality of teeth recessed from an inner circumferential surface outwards in a radial direction and formed along a circumferential direction;
a coil wound around the plurality of teeth; and
a thermal conductive unit provided on the inner circumferential surface of the stator body and configured to transfer heat from the inner circumferential surface of the stator body outwards in an axial direction,
the thermal conductive unit being made of a thermally conductive material to transfer heat from the inner circumferential surface of the stator body outwards in the axial direction, and comprising a conductive rod provided on the inner circumferential surface of the stator body and comprising a first end exposed to a first side of the stator body in the axial direction and a second end exposed to a second side of the stator body in the axial direction.

2. The stator core of claim 1, wherein the conductive rod is inserted in an empty space formed at an inner end of the tooth in a radial direction.

3. The stator core of claim 1, wherein the thermal conductive unit comprises:
a first conductive plate connecting with a first side of the conductive rod in the axial direction, and provided to be in contact with the first side of the stator body in the axial direction; and
a second conductive plate connecting with a second side of the conductive rod in the axial direction, and provided to be in contact with the first side of the stator body in the axial direction.

4. The stator core of claim 3, wherein the first and second conductive plates comprise:
a first tooth corresponding groove recessed from the inner circumferential surface outwards in the radial direction to correspond to the tooth of the stator body; and
a connection ring formed to seal an opening of the first tooth corresponding groove along the inner circumferential surfaces of the first and second conductive plates, and
an end portion of the conductive rod is coupled to the connection ring.

5. The stator core of claim 1, wherein the thermal conductive unit comprises copper, aluminum, a copper alloy, an aluminum alloy, or thermally conductive plastic.

6. The stator core of claim 2, wherein
the conductive rod comprises a plurality of conductive rods provided on only some of the plurality of teeth.

7. The stator core of claim 3, further comprising an oil flow groove formed on an outer circumferential surface of the stator body along the axial direction and recessed inwards in the radial direction to flow oil for cooling therein,
wherein the first and second conductive plates comprise oil corresponding grooves recessed from outer circumferential surfaces inwards to correspond to an end portion of the oil flow groove.
